(19) United States
(12) Patent Application Publication
(10) Pub. No.: US 2014/0239888 A1
(43) Pub. Date: Aug. 28, 2014

(54) WIRELESS CHARGER

(71) Applicant: Kuan-Wei CHEN, Taitung (TW)

(72) Inventor: Kuan-Wei CHEN, Taitung (TW)

(21) Appl. No.: 13/776,738

(22) Filed: Feb. 26, 2013

(51) Int. Cl. H02J 7/02

(52) U.S. Cl. CPC H02J 7/025
USPC 320/108

(57) ABSTRACT

A wireless charger includes an anti-slippery charger mat having a mat, inductive charger, power circuit board, and a plug, and a portable charging connector of the wireless charger including a casing, power inductor, receiving hole, indicator, and a connector terminal. The plug of the mat is inserted into a power socket of a vehicle, and the portable charging connector is inserted into the inductive charger of the mat through the receiving hole so that a device connected to the connector terminal of the portable charging connector can be powered or charged. The anti-slippery charger mat placed on top of a dashboard of vehicle is capable of holding objects placed on it during moving of the vehicle.

### FIELD OF THE INVENTION

The present invention relates to wireless charger, and particular to an anti-slippery charger mat powered by a power socket of vehicle and a portable charging connector arranged to the anti-slippery charger mat for charging a connected device such as a cell phone. When the anti-slippery charger mat is placed on the vehicle's dashboard, it is also capable of holding objects placed on the mat and prevents a drop during moving of the vehicle.

### DESCRIPTION OF THE PRIOR ART

Prior chargers consist of a plug and connector electrically connected through a power cord. A portable device such as a cell phone can only be recharged by a power cord on a vehicle while driving. However, it's not only easy to carry on but also difficult to supply power source right way to recharge if the portable device is ran of battery. Furthermore, the such chargers are only used to recharge a portable device without any other functions.

### SUMMARY OF THE PRESENT INVENTION

Accordingly, the primary object of the present invention is to provide a vehicle anti-slippery charger mat with a portable charging connector able to supply power to portable devices anywhere when the portable device is ran out of battery. The portable charging connector is inserted into the anti-slippery charger mat for recharging. Furthermore, when the anti-slippery charger mat is placed on the vehicle's dashboard, it is able to hold objects placed on the mat during moving of the vehicle.

To achieve above objects, the present invention includes an anti-slippery charger mat having a mat, inductive charger, power circuit board, and a plug. The inductive charger disposed on the mat is electrically connected to the power circuit board embedded inside the mat. The plug electrically connected to the power circuit board is extending out of the mat. The present invention also includes a portable charging connector able to insert into the anti-slippery charger mat. The portable charging connector includes a casing, power inductor, receiving hole, indicator, and a connector terminal. The power inductor is disposed inside of the casing and arranged around the wall of the receiving hole. The indicator is disposed on the casing and protruded from the casing. The connector terminal is also disposed with casing and protruded from the casing. The power inductor, indicator and connector terminal are electrically connected to each other.

### BRIEF DESCRIPTION OF THE DRAWINGS

FIG. 1 is an exploded perspective view showing a preferable embodiment of the present invention.

FIG. 2 is a cross-section view showing the assembly of the embodiment of the present invention.

FIG. 3 is a schematic view showing the embodiment of the present invention being placed on top of a dashboard of vehicle.

FIG. 4 is a schematic view showing the operation of the embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

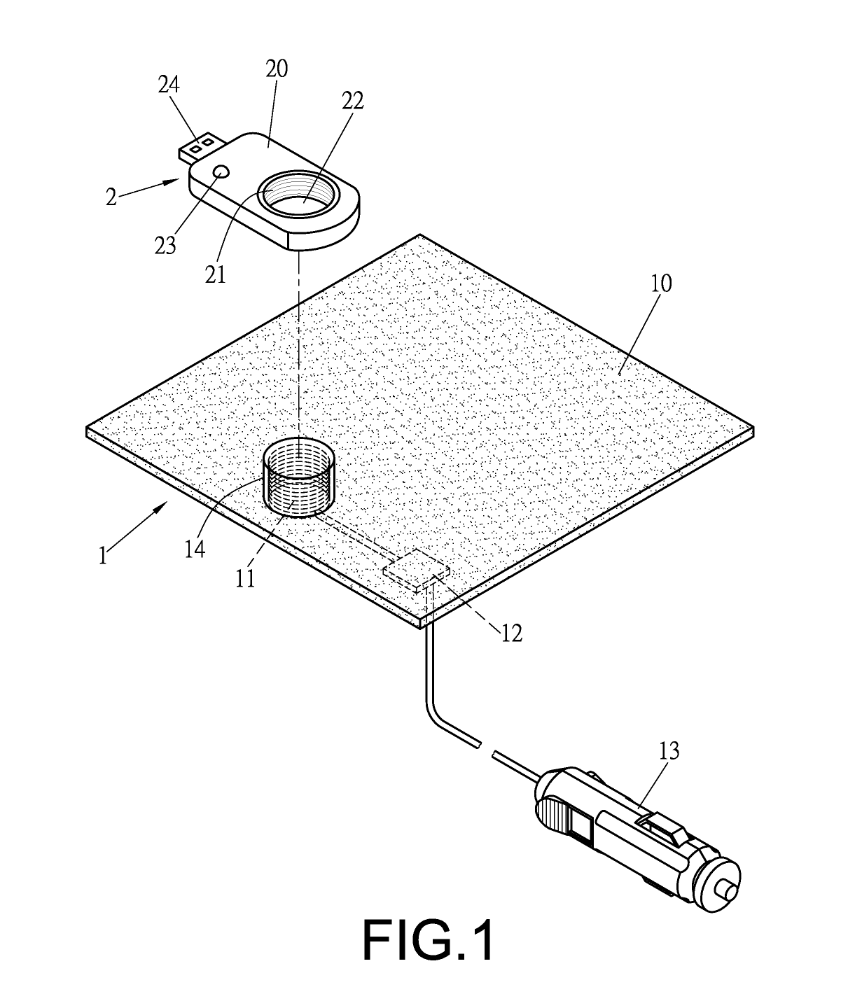

Referring to FIG. 1, a preferable embodiment of the present invention mainly includes an anti-slippery charger mat 1 consisting of a mat 10, inductive charger 11, power circuit board 12 and a plug 13. The mat 10 is made of silicone. The inductive charger 11 disposed on the mat 10 is protruded from the surface of the mat 10. The surface of inductive charger 11 is covered by skin 14 and the inductive charger 11 is connected to the power circuit board 12 embedded inside the mat 10. A plug 13 connected to the power circuit board 12 is extending out of the mat 10. The plug 13 is suitable for automobile power socket. The embodiment of the present invention also includes a portable charging connector 2 able to be inserted into the inductive charger 11 of the mat 10 consisting of a casing 20, power inductor 21, receiving hole 22, indicator 23, and a connector terminal 24. The casing 20 is made of either metal or plastic. The power inductor 21 disposed inside of the casing 20 is arranged around the wall of the receiving hole 22. The indicator 23 is a LED (light emitting diode) disposed on a surface of the casing 2 and protruded from the surface of the casing 20. The connector terminal 24 is a metal connector extending from the casing 20. The power inductor 21, indicator 23, and the connector terminal 24 are electrically connected to each other.

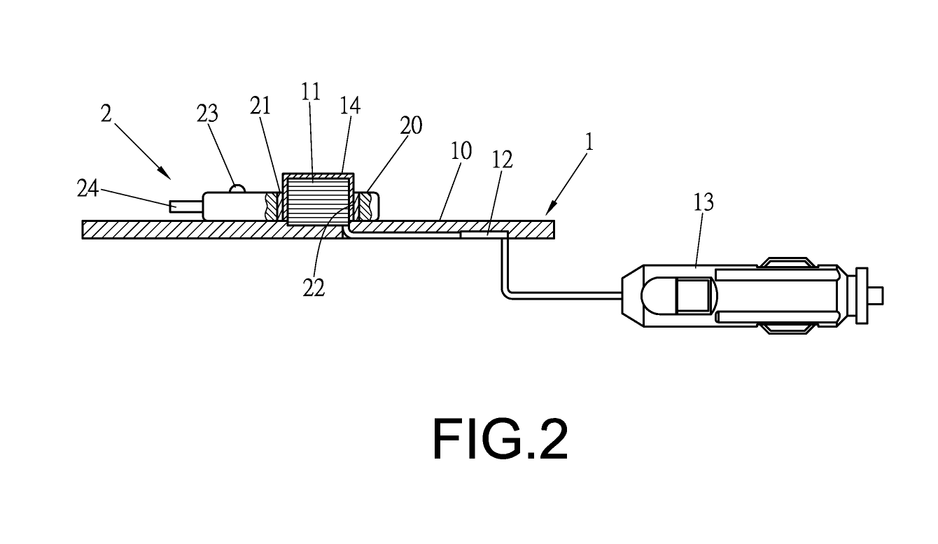

Referring to FIGS. 1 and 2, the assemblies of the anti-slippery charger mat 1 and the portable charging connector 2 are illustrated. The inductive charger 11 is electrically connected to the power circuit board 12 embedded into the mat 10. The plug 13 is extending from the power circuit board 12. The inductive charger 11 disposed on the mat 10 is protruded from the mat 10. The protrusion part of the mat 10 is covered by the skin 14. The power circuit board 12 is disposed insider of the mat 10. Hence, the assembly of the anti-slippery charger mat is completed. Additionally, the power inductor 21 of the portable charging connector 2 is disposed inside of the casing 20 and arranged around the wall of the receiving hole 22. The indicator 23 is protruded from the surface of the casing 20 of the portable charging connector 2. The connector terminal 24 is disposed on the casing 20 and protruded from the surface of the casing 20. The power inductor 21, indicator 23, and connector terminal 24 are electrically connected to each other.

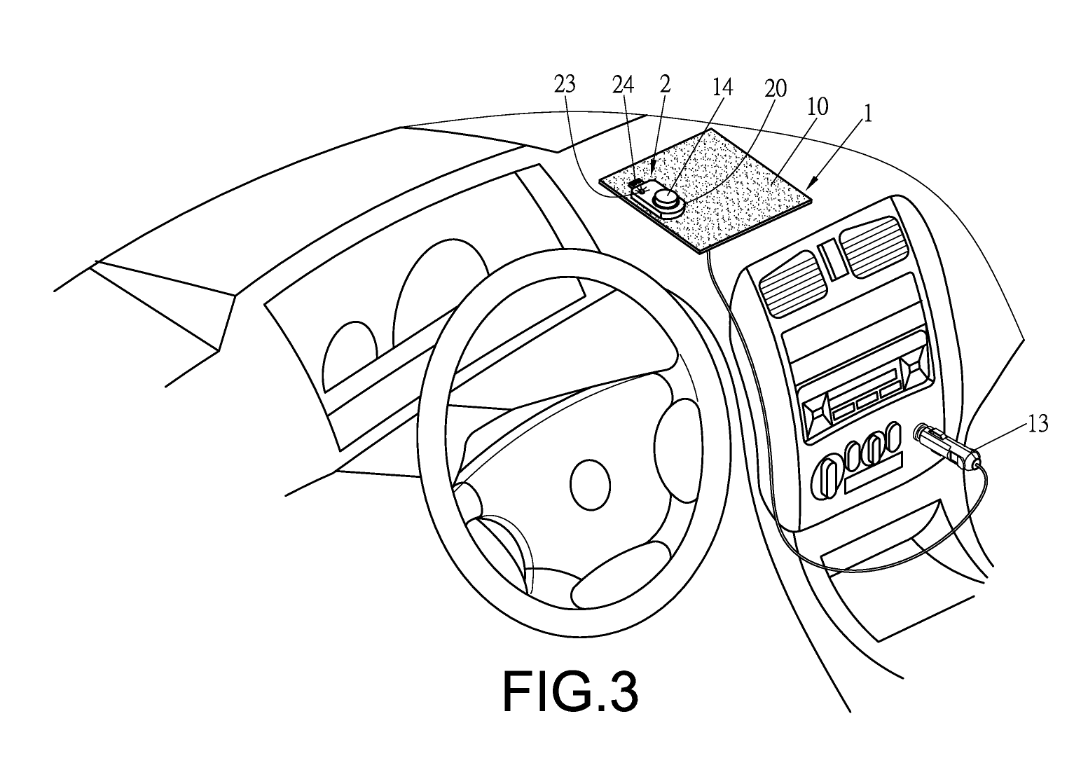

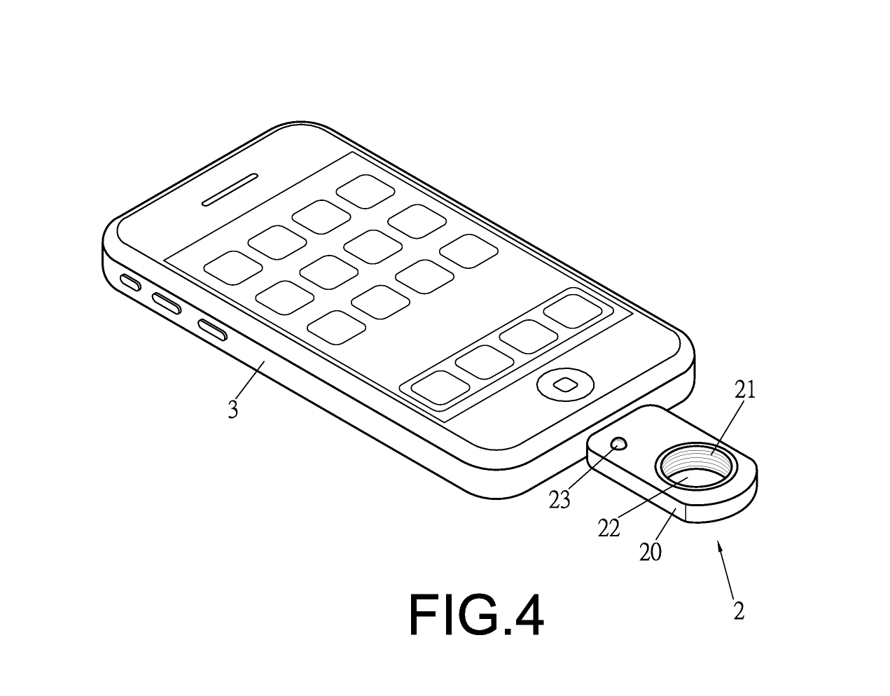

The operation of the anti-slippery charger mat 1 and portable charging connector 2 is illustrated in FIG. 2. The portable charging connector 2 serves to be inserted into the inductive charger 11 of the mat 1 through the receiving hole 22 so that the power inductor 21 around the receiving hole 22 is attached to the skin 14 of the mat 1. The plug 13 of the mat 10 can be inserted into a power socket of a vehicle as shown in FIG. 3. The indicator 23 of the portable charging connector 2 will light up upon the insertion of the plug 13 and power can be supplied and recharged to the portable charging connector 2. Therefore, the portable charging connector 2 is easy to carry on and able to supply power to a portable device 3 anywhere by inserting the connector terminal 24 as shown in FIG. 4. Furthermore, when the anti-slippery charger mat 1 is placed on top of a dashboard of vehicle, it is capable of holding objects placed on the mat 1 during moving of the vehicle.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A wireless charger comprising:
an anti-slippery charger mat having a mat, inductive charger, power circuit board, and a plug; the inductive charger arranged on the mat and electrically connected to the power circuit board embedded inside the mat; the plug electrically connected to the power circuit board extending out of the mat;
a portable charging connector inserted into the inductive charger of the anti-slippery charger mat; the portable charging connector consisting of a casing, power inductor, receiving hole, indicator and a connector terminal; the power inductor disposed on the casing and arranged around the wall of the receiving hole; the indicator disposed on the casing and protruded from the surface of the casing and the connector terminal also disposed on the casing and extended from the surface of the casing. The power inductor, indicator, and the connector terminal are electrically connected to each other.

2. The wireless charger as claimed in claim 1, wherein the mat of the anti-slippery charger mat is made of silicone.

3. The wireless charger as claimed in claim 1, wherein the inductive charger of the anti-slippery charger mat is covered by a skin, and the inductive charger is protruded from a surface of the anti-slippery charger mat.

4. The wireless charger as claimed in claim 1, wherein the plug of the anti-slippery charger mat serves to be inserted into a power socket of a vehicle.

5. The wireless charger as claimed in claim 1, wherein the casing of the portable charging connector is made of either metal or plastic.

6. The wireless charger as claimed in claim 1, wherein the indicator of the portable charging connector is an LED.

7. The wireless charger as claimed in claim 1, wherein the connector terminal of the portable charging connector is made of metal.
